(19) United States
(12) Patent Application Publication
(10) Pub. No.: US 2010/0236144 A1
(43) Pub. Date: Sep. 23, 2010

(54) Container for Growing Plants and Carrier Therefor

(75) Inventor: Peter Lawton, Berwick (AU)

Correspondence Address: JOHN ALEXANDER GALBREATH, 2516 CHESTNUT WOODS CT, REISTERSTOWN, MD, 21136, US

(73) Assignee: TRENTCOM APS PTY. LTD., Berwick, VIC (AU)

(21) Appl. No.: 12/664,400

(22) PCT Filed: Jun. 16, 2008
(86) PCT No.: PCT/AU2008/000866

§ 371 Date: Apr. 29, 2010

(30) Foreign Application Priority Data
Jun. 14, 2007 (AU) 2007903202

(51) Int. Cl. A01G 9/02

(52) U.S. Cl. 47/65.9; 47/65.5

(57) ABSTRACT

A container for seedlings to be grown by the air root pruning method is moulded as a flat plastic blank with walls hinged for folding and base hinged to one of the walls permitting the container to be erected by engaging the walls and the base and attaching one wall to another. The erected containers stand in a tray like carrier and are connected together by a tie which overlies the containers. A handle extends through the tie to engage the carrier allowing a group of containers to be handled.

### FIELD OF THE INVENTION

The present invention relates to a container for growing plants. In particular, the invention relates to a container for growing plants that is assemblable from a blank by relative movement of the walls and base thereof.

### BACKGROUND OF THE INVENTION

In this specification, where a document, act or item of knowledge is referred to or discussed, this reference or discussion is not an admission that the document, act or item of knowledge or any combination thereof was at the priority date.
(I) part of common general knowledge, or
(ii) known to be relevant to an attempt to solve any problem with which this specification is concerned.

Published PCT specification WO 97/21339 describes a plant growth container with transformable walls. In an unassembled form, the container comprises a base portion and walls that extend radially outwardly from the base. The container is assembled by pivoting each wall about the line at which it connects to the base through an angle of approximately 90° and then by securing the walls together. The walls and base of the plant growth container are perforated to facilitate air root-pruning of a plant grown therein.

Whilst this transformable-wall container is a suitable product it is nevertheless difficult to efficiently mass produce by injection moulding. It has also been found that the transformable walls occasionally separate once the container is put into use.

It is an object of the present invention to improve on, or at least to provide an alternative to, the container described in WO 97/21339.

### SUMMARY OF THE INVENTION

According to the invention there is provided a container for growing plants comprising:

an integral wall member defining one or more container walls and having means for attaching the wall member to itself to form a closed shape; and
a base attachable to the wall member,
wherein the container is assemblable by engaging parts of the wall member with the base, and by attaching the wall member to itself.

Rather than providing separate walls, each of which is attached to the base and assembling the container by attaching the walls to each other, as per the prior art container described above, the present invention proceeds by way of an integral wall member that defines the walls that makes up the container, which may be attached to itself in order to assemble the container.

This arrangement is believed to provide stronger containers in both the unassembled and assembled form. Strength is important to containers in an unassembled form to minimise the chance of damage during transportation. Containers according to the invention have a single connection region between the container walls and base, rather than four connection regions (ie. one for each wall), as per the prior art container described above. As the connection region tends to be the part of the container most likely to be damaged during transportation, minimising the number of such regions results in a stronger container.

Strength is also important to containers in an assembled form, to ensure that they don't come apart or suffer distortion from the expanding root ball of a plant grown within the container. This is thought to be less likely for containers according to the present invention, because the integral wall member is joined to itself at a single site, rather than having four separate sites of connection between each wall, as per the prior art.

Preferred embodiments of containers according to the invention can also be moulded more efficiently than the transformable-wall container described above. A 1.5 litre container will be injection moulded in a machine with a platen area of around 2,000 cm² compared with a 1.5 litre transformable-wall container requiring a platen area in excess of 3,000 cm².

The lower moulding machine capacity required and the resulting lower cost arise from a matching reduction in the “empty space” found in containers according to the invention in unassembled form, in comparison to the empty space found in the transformable-wall container in a similarly unassembled form.

The wall member may define one or more separate container walls, with the number of defined walls corresponding to the horizontal cross-sectional shape of the assembled container. A single container wall results in a container with a circular cross-section, whereas the four defined container walls of equal length result in a square container. It will be realised by those skilled in the art that a wide variety of container shapes is possible according to the present invention.

Typically, the container walls are defined between one or more spaced apart flexible regions that extend in a direction parallel to the longitudinal axis of an assembled container, the arrangement being such that the container walls are movable relative to each other and to the base by pivoting about a flexible region, and the container is assembled through such relative movement.

In particularly preferred embodiments, the flexible regions are integrally formed with the wall member as areas of reduced thickness in comparison to adjacent parts of the wall member. Optionally, the flexible regions are generally U-shaped in vertical cross section.

The wall may engage with the base through any convenient means. In preferred embodiments the wall member includes opening(s) along an edge thereof that are adapted for engagement with one or more members that project out of the periphery of the base.

The wall member and base may also have openings therein for facilitating air root pruning of a plant grown within the container. In particularly preferred embodiments the openings are at the end of generally truncated-pyramid shaped projections, that enable unassembled containers to be stacked one on top of the other in a space-efficient manner. Truncated-pyramid shaped projections are also beneficial in the air-root pruning context.

The projections may also define a guide way when the wall member is attached to itself, into which a holding means may be inserted to provide additional strength to the closure means.

The means for attaching the wall member to itself to form a closed shape may be provided in any convenient manner. In preferred embodiments the means includes one or more tabs spaced apart in a direction substantially parallel to the longitudinal axis of an assembled container, the tabs being adapted to engage with corresponding slots located elsewhere on the wall member.

In particularly preferred embodiments each slot is provided in a projecting portion of the wall member.

Typically, in an unassembled condition, the container is in the form a substantially planar blank.

### BRIEF DESCRIPTION OF THE DRAWINGS

An embodiment of a container for growing plants in accordance with the present invention will now be described with reference to the accompanying drawings in which:

FIG. 1 is a perspective view of a blank, from which a container according to the present invention may be assembled.

FIG. 2 is a plan view of the blank illustrated in FIG. 1.

FIG. 3 is an elevation view of the blank illustrated in FIGS. 1 and 2.

FIG. 4 is a perspective view of an assembled container according to the present invention.

FIG. 5 is a perspective view of a carrier for ten containers (two shown) with a container tie and a removable carrier handle.

FIG. 6 is a plan view of the tie holding ten containers.

FIG. 7 is a side view of the empty carrier and tie connected by a variant carrier handle.

### DETAILED DESCRIPTION WITH RESPECT TO THE DRAWINGS

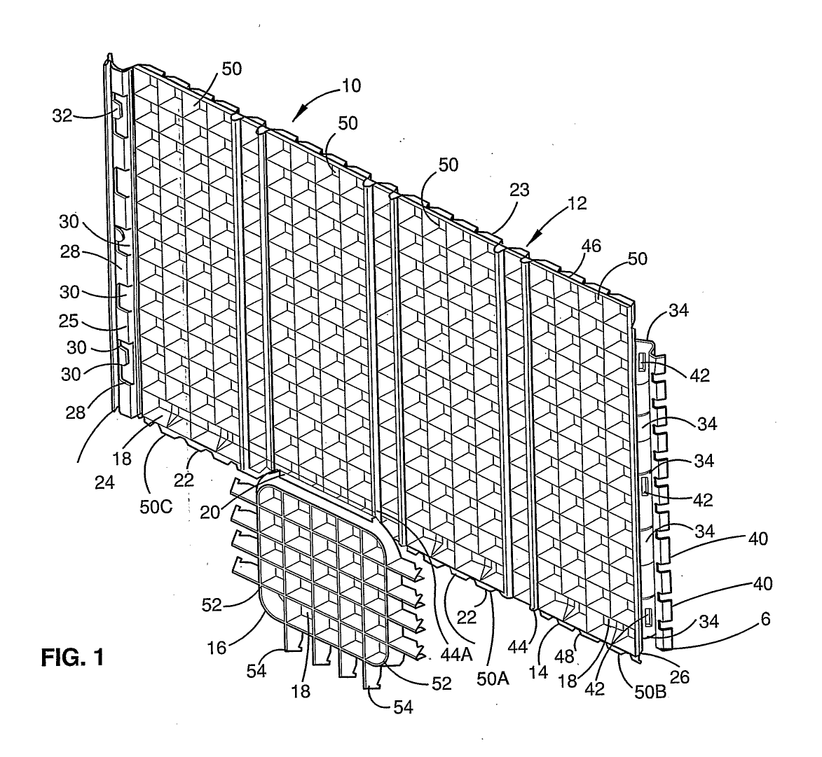

An embodiment of a container 10 for growing plants in accordance with the present invention is illustrated in FIGS. 1 to 5. The container 10 is assembled form a substantially planar blank 12 that is manufactured from a suitable material, typically injection-moulded polypropylene or high density polyethylene. The blank 12 is manufactured as a single piece 0.9 mm in thickness.

Blank 12 is composed of a wall member 14 and a base 16. Rows and columns of outwardly projecting, truncated pyramid-shaped cuspations 18 are provided in both the wall member 14 and base 16 to facilitate “3 dimensional” air root pruning (ie. pruning of roots at both the wall and base) of a plant grown within the container. The shape of the cuspations also allow blanks 12 to be efficiently stacked one on top of each other for transportation, with the outwardly-projecting cuspations of each blank nesting within the interior of the cuspations in the blank below.

The shape of the cuspations 18 and the associated stacking arrangement allows container blanks 12 to have a stacking height of around 5.0 mm. The blanks 12 have been designed to minimise warehousing and distribution costs. Packets of 100 to 200 stacked blanks 12 can be dispatched directly from the manufacturing facility to the consumer ‘just in time’. Small volumes may be delivered through the postal service. Large volumes (ie. up to 160,000 units) may be shipped in a 40 ft TEU shipping container.

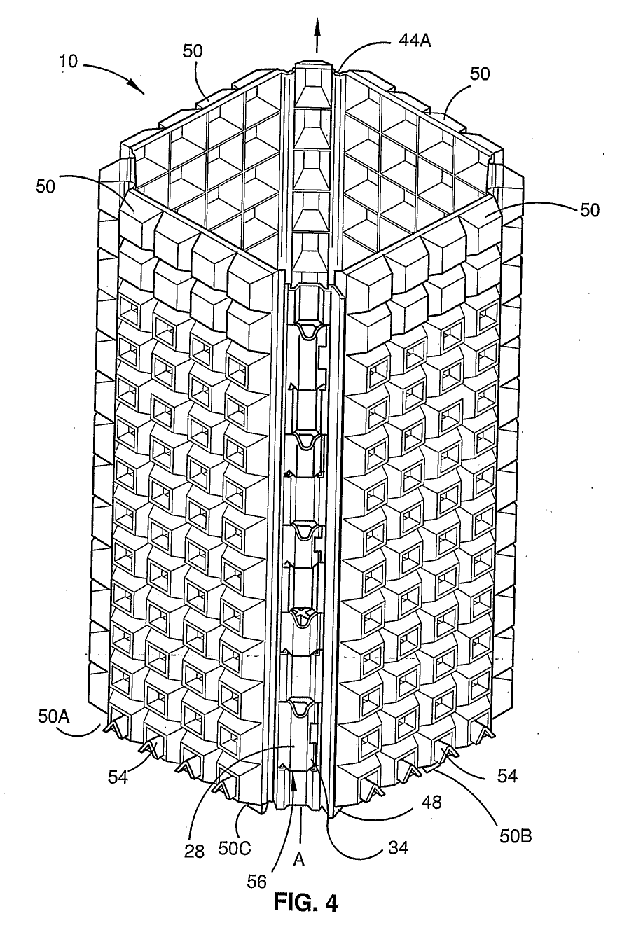

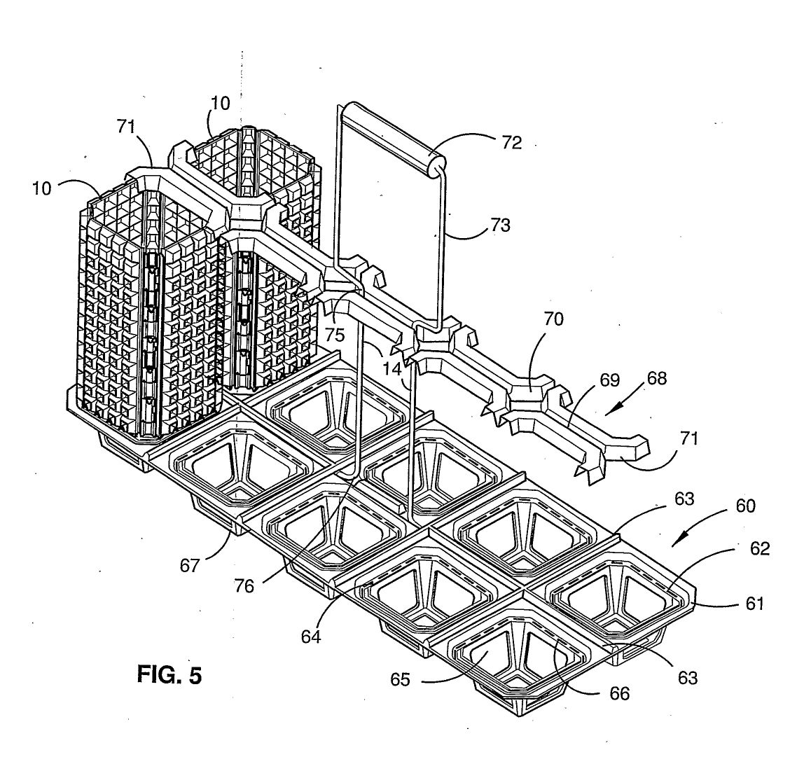

The wall member 14 is rectangular in shape and includes a pair of opposed longitudinal edges 22, 23 and a pair of opposed lateral edges 24, 26. Once the container 10 is assembled (FIG. 5) the longitudinal axis, marked ‘A’ in FIG. 4, extends in parallel to the lateral edges 24, 26 of the wall member 14.

The base 16 is generally square in shape with rounded corners and is operatively connected to the wall member 14 along a part of the length of longitudinal edge 23 via a flexible hinge member 20. A series of fingers 52 extend beyond the three sides of the base 16 that are not connected to the wall member 14.

The member 20 acts as a hinge in allowing pivotal movement of the base 14 and wall member 14 relative to the other. A series of teeth 21 extend from points along the longitudinal edge 23 at which the base 16 is not connected.

A plurality of spaced apart, flexible regions 44 having a U-shaped profile extend between the longitudinal edges 22, 23 of the wall member in parallel to the lateral edges 24, 26. A container wall 50 is defined between each adjacent pair of these flexible regions 44. Each container wall 50 is free to move out of the plane of the wall member 14, by pivoting the container wall 50 about one of its bounding flexible regions 44.

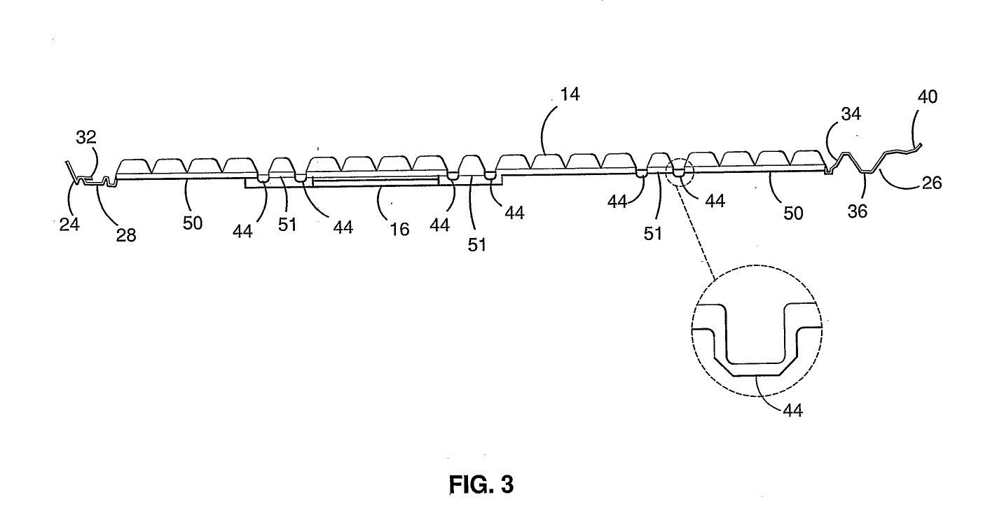

Any number of container walls 50 may be defined through the provision of a suitable number of flexible regions 44 with the number of container walls in turn defining the horizontal cross-sectional shape of the assembled container. In the illustration embodiment there are 8 flexible regions 44 which define four major container walls 50, each of which is four cuspations in length and three minor container walls 51, each of which is one cuspation in length. This arrangement results in an assembled container (FIG. 5) with a generally square horizontal cross-sectional shape, with diagonal, rather than right-angled corners. The detail in FIG. 3 shows an enlarged hinge with corners reduced in thickness to 0.4 mm.

Avoidance of right-angled corners in plant growth containers is important as containers that include such angles have been associated with root crowding in the corner regions.

Assembly of the container 10 form the blank 12 is through a simple, two-part operation of engaging the wall member 14 with the base 16, and then closing and securing the wall member 14 to itself. The simplicity of the assembly operation makes it equally adaptable to small-scale manual assembly, or large-scale automated assembly, at a purpose-built mechanised assembly station.

The wall member 14 may be closed and secured in this way, through cooperating formations provided on the lateral edges 24, 26 of the wall member 12. A plurality of U-shaped members 28 extend out of the plane of the wall member 12 along lateral edge 24, and a series of recesses 30 are defined between the U-shaped members 28. Tabs 32, extending along lateral edge 24 and lying in a plane parallel to the plane of the wall member 14, projecting into the recesses 30.

Multiple bridging members 34 extend along lateral edge 26 and project out of the plane of the wall member 14 in the opposite direction to the U-shaped members 28. A spine 36 is attached along the edges of the bridge member 34 and a series of teeth 40 extend from the spine 36. An aperture 42 is provided in three of the bridge members 34.

Turning to FIG. 4, a currently preferred method of assembling the container is illustrated. Firstly, the unassembled blank 12 is placed on a flat surface with longitudinal edge 23 at the bottom and longitudinal edge 22 and base 16 on top.

Next, the base 16 is pivoted about flexible member 20 through an angle of approximately 90°. The interior major container wall 50A is then pivoted about flexible region 44A through an angle of approximately 90°. During this action each cuspation 18 in the lowest row of container wall 50A is made to slide over a finger 52 that extends from the base.

Container walls 50B and 50C are then sequentially pivoted about an adjacent flexible region 44B, 44C in a similar manner until an entire row of cuspations is engaged over the fingers 52.

Finally, the wall member is secured to itself at its lateral edges 24, 26, by inserting the tabs 32 into the recesses 42 in the bridging member 34.

The assembled container 10 is then turned right-way-up, with the base 16 on the ground, and is ready to be filled with a growing medium at an automated filling station followed by seed addition through a seed drill.

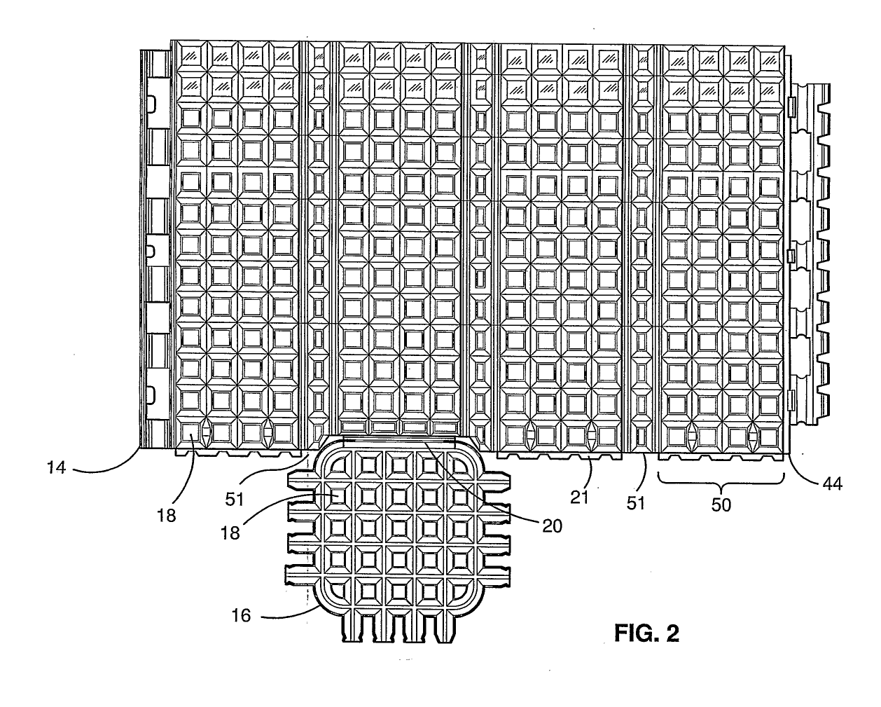

This method of assembling containers allows longitudinal edge 23 (see FIG. 2) to rest on a firm surface making for a less-cumbersome assembly. It also allows blanks to be folded around a hollow former (not shown) that has been filled with the precise volume of growing medium that is required to fill an assembled container. The assembled container and former can then be inverted as one, so that the container receives the growing medium, with the former then being removed.

The filled container is then tapped or vibrated gently to ensure that the growing medium fills all of the truncated pyramidal cavities. Tapping or vibrating has been found to be important for Consistent porosity and consistent root growth and air pruning as the seed grows. Pre-measuring the volume of medium means that the media in the container will settle to a consistent height. The top two rows of cuspations are devoid of apertures because the growing medium settles.

These operations can be automated and in turn help other automated operations after the seedling has emerged. Automated operations after germination may include “watering by weight” and culling multiple seedlings.

The teeth 21 that extend out of the base of the assembled container 10 are receivable in a cooperating formation that is provided in a nursery floor or a plant growth tray (as illustrated in WO 97/21339), so that the container is firmly held in place. The vertical length of the teeth 21 is such that a space (typically of around 50 mm) is provided between the base 16 of the container and the surface in which the teeth 21 are engaged. This allows for adequate air root-pruning of roots that extend out of the cuspations in the container base 16. The gap also allows for laminar water flow to heat or cool the growth environment of the plants grown within the containers.

It will be noted that a guide way 56 is defined by the bridging members 34 once the container is assembled. For additional container strength, a rod (not shown) may be slid along the guide way 56 to more fully secure the container in the closed position. However this is not essential as the container is very securely fastened by operation of the tab 32 and recess 42 combination.

The container may be easily disassembled by depressing the V-section bridging members 34 allowing the removal of the tabs 32 from the apertures in the bridging member and then unwrapping the container walls 50 out of engagement with the fingers 54. The disassembled container may then be returned to the form of a substantially planar blank for storage and/or transportation purposes.

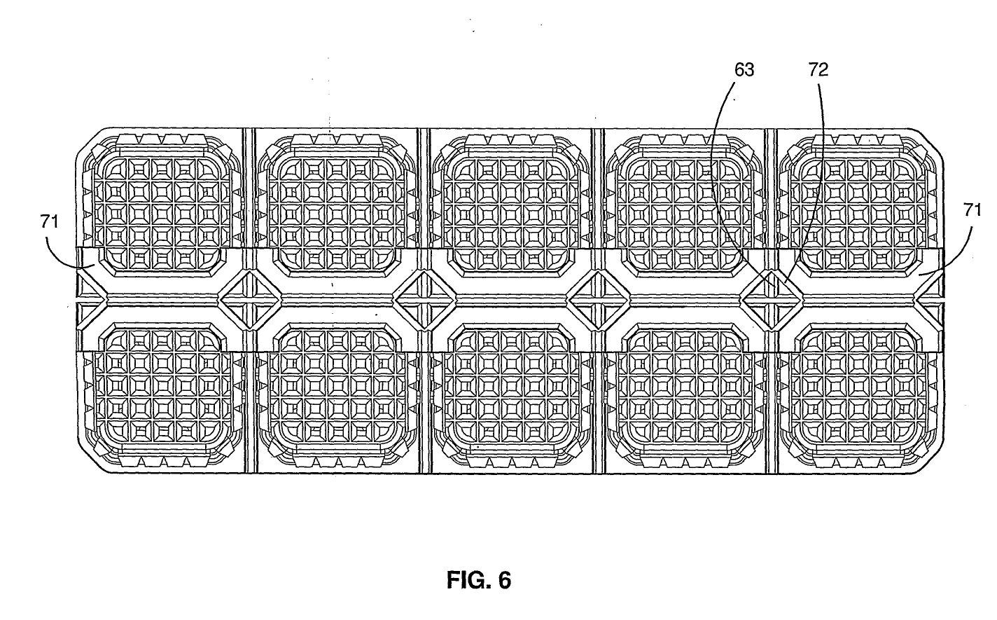

The 1.5 litre containers are intended for nursery use where it is useful to be able to handle clusters of containers. While the tray referred to above may be utilised the variant in FIGS. 5 and 6 is effective in allowing operators to lift ten containers with each arm.

In FIG. 5 grid base 60 is a single moulding consisting of a tray 61 divided into two rows of five seats 62 by ribs 63. Each square seat has a recess 64 of tapered cross-section in order to receive the bottom of a container. The annular horizontal margin 65 which defines a central hollow is perforated. The perforations are slots 66 which correspond to the tongues 21 on the lower edge of the container. Thus when a container is placed on the grid base the tapered recess guides the container until the teeth 21 (see FIG. 2) enter the slots 66.

The grid base is raised above the ground by ten integral convex legs 67, one for each seat. The ground spacing is about 50 mm and allows both drainage, an air gap from any cold ground and air contact to promote root pruning. The containers lie close together as shown in FIG. 5 in order to use the floor area economically (see FIG. 6).

The containers are further stabilised by moulded tie 68 of inverted M-section with a spine 69 joining four connector sites 70 and two end connector sites 71. The connector sites 70 overlie the adjacent bevelled corners of four containers covering the top row of cuspations and the rim of one wall. A square space 72 in the centre of each site is created. The tie need only overlie a pair of adjacent corners in each container and the single wall which joins the pair to exert an adequate stabilising force on all ten. The tie can be lifted off the containers when the group is to be split up. The end sites 7 each correspond to half a connector site because the spine end need only mutually connect the end pair of containers.

Handle 72 consists of a handgrip through which an inverted U-shaped wire 73 passes.

The descending wire limbs 74 of the handle project downwardly through a pair of apertures 75 in the tie and continue downwards into the two eyes 76 in the axial rib 63. Squeezing the limbs towards each other allows them to leave the eyes and be withdrawn from the tie and carrier.

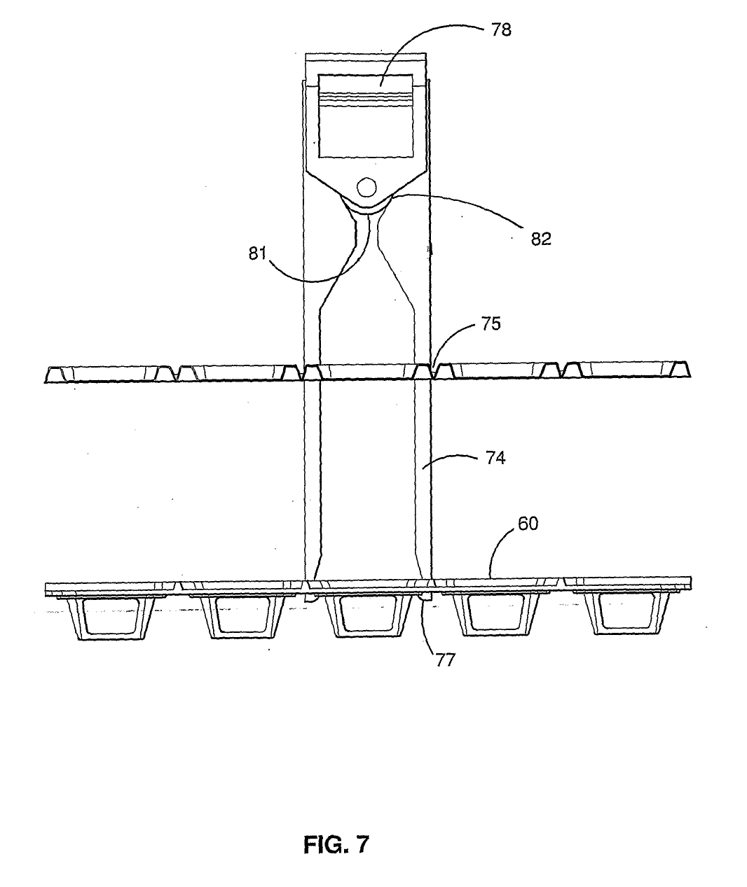

Referring now to FIG. 7 which shows an alternative moulded handle, the limbs 74 project through apertures 75 in the tie and the spurs 77 engage eyes in the grid base 60. The limbs project from a J-section grip 78. The U-shaped part 80 has a wheel 81 which bears against the ramp faces 82 of the limbs. Downward manual pressure diverges the limbs while lifting force on the grip 78 raises to carrier.

We have found the advantages of the above embodiment to be:

1. High packing density for shipping in the blanks, grid bases and ties.
2. High resistance to accidental opening when once assembled.
3. Resistance to damage in the transported form.
4. Suitable for robotic assembly.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. these modifications and/or additions are therefore considered to fall within the scope of the invention.

1. A container for growing plants erectable from a planar blank comprising an integral wall member defining one or more container walls and having means for attaching the wall member to itself to form a closed shape and a base attachable to the wall member wherein the container is erectable by engaging parts of the wall member with the base and by attaching the wall member to itself.

2. A container as claimed in claim 1, wherein the wall member defines one or more individual container walls, the number of walls corresponding to the horizontal cross-sectional shape of the assembled container.

3. A container as claimed in claim 1, wherein the walls each lie between one or more mutually spaced flexible margins which extend in a direction parallel to the longitudinal axis of the erected container, the arrangement being such that the walls are foldable relative to each other and to the base by pivoting about a margin and the container is erectable through such folding movements.

4. A container as claimed in claim 3, wherein the flexible margin is a moulded hinge of U-section.

5. A container as claimed in claim 3, wherein the flexible margin is a pair of moulded hinges which are mutually spaced thereby creating a bevelled edge between adjacent walls.

6. A container as claimed in claim 1, wherein the wall member has apertures along an edge hereof adapted for engagement with fingers which project out of the periphery of the base.

7. A container as claimed in claim 6, wherein the apertures facilitate air root pruning of a plant grown in the container and the fingers snap through the apertures.

8. A container as claimed in claim 7, wherein the projections which define the apertures also define a guide way when the wall member is attached to itself, into which a keeper is insertable.

9. A container as claimed in claim 1, wherein the means further comprises one or more tabs spaced apart in a direction substantially parallel to the longitudinal axis of an erected container the tabs being adapted to engage corresponding slots located elsewhere on the wall member.

10. A planar blank for erection into a plant container comprising an integral wall number defining one or more container walls and having means for attaching the wall member to itself to form a closed shape and a base attachable to the wall member wherein the container is erectable by engaging parts of the wall member with the base and by attaching the wall member to itself.

11. A carrier for multiple plant containers defined in claim 1, the carrier comprising a grid base with a container support surface, legs supporting the grid base above the ground, seats at the support surface for engaging the lower edges of the erected containers and an elongated connector with projections arranged to engage the upper edges of the containers when seated on the grid base thereby connecting pairs of containers to adjacent pairs of containers.

12. A carrier as claimed in claim 11, wherein each seat is a recess corresponding in shape to the lower edge of the erected container.

13. A carrier as claimed in claim 11, wherein each seat has lines of slots which correspond to the periphery of the lower edge of the erected container and are intended to receive teeth extending from the lower edge of the container.

14. A container as claimed in claim 12, wherein the base has one or more entries along a substantially central grid axis for the reception of the limbs of a carrier handle.

15. A carrier as claimed in claim 11, wherein the connector is of inverted channel section with pairs of connector sites, each site embracing two adjacent corners of a container together with the wall joining the two corners.

16. A carrier as claimed in claim 15, wherein the connector site has connector channels which mutually connect four corners of four containers arranged in a grid on the grid base and a spine connects the sites in series.

17. A carrier as claimed in claim 16, wherein the connector has one or more apertures in the spine to allow the passage of a carrier handle.

18. A carrier as claimed in claim 17, wherein a handle with a pair of downwardly projecting ends passes through the spine apertures and engages the grid base through the entries therein.

19. A carrier as claimed in claim 14, wherein the handle transmits any lifting force through a pair of limbs, the ends of which engage the grid base thereby raising the grid base and any pushing force through the limbs which diverges the limbs and disengages the ends attaching the handle to separate from the grid base.

20. A carrier as claimed in claim 19, wherein the limbs each have a ramp surface and a hook for engaging the grid base and the handle is a grip with a slot which allows lifting motion to raise the limbs and descending motion to relieve tension on the limbs and force the limbs apart by riding on the ramp faces thereby unhooking the limbs from the grid base.
